(19) United States
(12) Patent Application Publication
(10) Pub. No.: US 2011/0200804 A1
(43) Pub. Date: Aug. 18, 2011

(54) REINFORCED PLATE GLASS AND METHOD FOR MANUFACTURING THE SAME

(76) Inventors: Masahiro TOMAMOTO, Otsu-shi (JP); Tatsuya Takaya, Otsu-shi (JP); Hiroshi Takimoto, Otsu-shi (JP)

(21) Appl. No.: 13/010,017

(22) Filed: Jan. 20, 2011

(30) Foreign Application Priority Data
Feb. 12, 2010 (JP) 2010-028873

(51) Int. Cl. B32B 17/00; C03B 23/203

(52) U.S. Cl. 428/213; 65/41

(57) ABSTRACT

Provided is a method, including: performing heat treatment under a state in which a thick core plate glass (2a) having a higher thermal expansion coefficient and a thin surface-layer plate glass (3a) having a lower thermal expansion coefficient are brought into surface-to-surface contact so that a bonding surface (2x) and (3x) of the core plate glass (2a) and the surface-layer plate glass (3a) attain a close contact state, thereby directly bonding the core plate glass and the surface-layer plate glass (2a) and (3a); then, additionally performing heat treatment so that the surface-to-surface contact portion has a temperature equal to or higher than a lower strain point out of strain points of the core plate glass and the surface-layer plate glass; and then, performing cooling so as to attain a temperature lower than the lower strain point, to thereby form a compression stress in a surface layer portion (3) corresponding to the surface-layer plate glass (3a) and form a tensile stress in a core portion (2) corresponding to the core plate glass (2a).

### TECHNICAL FIELD

The present invention relates to a reinforced plate glass used for a substrate material, a cover glass member, or the like to be mounted on, for example, an image display portion or an image input portion of various kinds of portable information terminals typified by a mobile phone and a PDA and an electronic appliance typified by a liquid crystal display, or on a solar light inlet of a solar cell, and to a method for manufacturing the same.

### BACKGROUND ART

As is known well, progress has been continuously made in recent years in technological innovation regarding various kinds of information-related terminals, for example, portable appliances such as a mobile phone, a digital camera, and a PDA or an image display apparatus such as a liquid crystal television. Such information-related terminals include a transparent substrate mounted thereon, as a substrate material for displaying information such as images and characters or for inputting information with a touch panel display or the like, or as a cover member. Moreover, in addition to the above-mentioned portions of the information-related terminals, a transparent substrate is installed in, for example, a solar light inlet of a solar cell. Those transparent substrates are required to secure reduction of environmental load and high reliability, and hence glass is adopted as a material for the transparent substrates.

Glass substrates used for applications of those kinds are required to have high mechanical strength and to be thin and light. In view of the foregoing, as a glass substrate meeting such demands, Patent Literature 1 discloses a so-called reinforced plate glass produced by subjecting surfaces of a plate glass to chemical strengthening by ion exchange or the like. For example, when a TFT device is formed on the reinforced plate glass of this kind, the original glass is desirably free of alkali metals. However, there is a problem in that if alkali-free glass is used for satisfying the demands as mentioned above, the above-mentioned chemical strengthening cannot be realized.

On the other hand, Patent Literature 2 discloses that a laminate substrate in which a plurality of plate glasses are laminated includes a transparent glass core having a higher thermal expansion coefficient and a pair of transparent glass skin layers each having a lower thermal expansion coefficient and being arranged at outermost layers on one of both sides of the transparent glass core in its plate thickness direction, thereby forming a compression stress in the transparent glass skin layers and a tensile stress in the transparent glass core.

According to this laminate substrate, the compression stress in the transparent glass skin layers and the tensile stress in the transparent glass core may cause the substrate to produce stored energy for enhancing resistance to the occurrence and propagation of flaws, without any restriction regarding the materials of the plate glasses. Thus, it is expected that the laminate substrate may contribute to prevent the breakage of the substrate and to suppress the occurrence of contaminated glass pieces.

### CITATION LIST

### Patent Literature

Patent Literature 1: JP 2006-83045 A
Patent Literature 2: JP 2008-522950 A

### SUMMARY OF INVENTION

### Technical Problem

By the way, in the laminate substrate forming the reinforced plate glass disclosed in Patent Literature 2 described above, it is required to form a compression stress in a surface layer portion and a tensile stress in a core portion. Thus, as described in paragraph [0062] in the same literature, it is said to be advantageous to perform lamination while molten glass is being formed into a sheet shape, in order to attain sufficient bonding between adjacent layers.

However, if such a lamination technique as described above is adopted, work for lamination must be carried out in the midst of a process of forming a plate glass in which molten glass is formed into a sheet shape. Thus, the lamination work of high-temperature glass sheets that are continuously delivered becomes extremely troublesome and cumbersome, resulting in inevitable deterioration of workability. Moreover, when the lamination work described above is carried out, a work region (work site) is limited, and hence there is a fatal problem in that the degree of freedom in the work becomes extremely small because a space necessary for the work cannot be sufficiently secured or the work is strictly restricted by the temperature and atmosphere of the work region.

In order to cope with the above-mentioned problem in this case, it is possible to manufacture a reinforced plate glass by using plate glasses after forming, but for this purpose, it is necessary for a plurality of plate glasses to be melt-bonded at each of their bonding surfaces. However, when the technique of simply melting and bonding each plate glass at each bonding surface is adopted, the following inconvenience may cause.

That is, in order to bring the bonding surfaces of plate glasses to a high-temperature state necessary for melting and bonding the bonding surfaces, not only the bonding surfaces of the plate glasses but also the whole plate glasses must be brought to the high-temperature state. Particularly in the case of a thin plate glass, the surface property and condition of its outer surface may deteriorate or bad phenomena such as deflection and warpage may be caused, resulting in production of a reinforced plate glass in which accomplishment of high quality has been blocked.

In addition to that, a large pressing force necessary for melting and bonding the bonding surfaces must be applied to the bonding surfaces between the plate glasses, and the plate glasses must be properly positioned and temporarily fixed so that the bonding surfaces between the plate glasses are not displaced with respect to each other when the adjacent bonding surfaces are melt-bonded. Thus, in order to properly position and temporarily fix plate glasses in a high-temperature state and then to apply a large pressing force to the adjacent bonding surfaces, it is essential to use a complicated, high-precision apparatus, not only resulting in high production cost but also resulting in a sharp increase in the cost of equipment. Besides, when the technique described above is used, it may take a long time for heating and work efficiency may deteriorate, leading to the reduction of productivity.

Thus, in the process of manufacturing a reinforced plate glass by laminating a plurality of plate glasses, it may be advantageous if each plate glass can be properly positioned and temporarily fixed so that the position of the each plate glass is not displaced with respect to each other. However, it is extremely difficult to properly position and temporarily fix the each plate glass by simple means under the technique of this kind that essentially requires heating under high temperature. Thus, any specific technique for the proper positioning and temporary fixing has not been currently discovered.

In consideration of the above-mentioned circumstances, a technical object of the present invention is to enable each of a plurality of plate glasses to be properly positioned and temporarily fixed under a low-temperature state by a simple technique in manufacturing a reinforced plate glass by laminating the plate glasses, so that subsequent heating treatment under high temperature can be properly carried out, thereby reducing the production cost and the cost of equipment.

### Solution to Problem

A method for manufacturing a reinforced plate glass according to the present invention, which has been devised for solving the above-mentioned technical problems, includes: performing heat treatment under a state in which a thick core plate glass having a higher thermal expansion coefficient and a thin surface-layer plate glass having a lower thermal expansion coefficient are brought into surface-to-surface contact so that a bonding surface between the core plate glass and the surface-layer plate glass attain a close contact state, thereby directly bonding the core plate glass and the surface-layer plate glass; then, additionally performing heat treatment so that the surface-to-surface contact portion has a temperature equal to or higher than a lower strain point out of strain points of the core plate glass and the surface-layer plate glass; and then, performing cooling so as to attain a temperature lower than the lower strain point, to thereby form a compression stress in a surface layer portion corresponding to the surface-layer plate glass and form a tensile stress in a core portion corresponding to the core plate glass. Here, the above-mentioned phrase “directly bonding” means a state in which a bonding surface of the core plate glass and the bonding surface of the surface-layer plate glass are directly bonded without interposing another layer such as an adhesive layer or a glass frit layer between both the bonding surfaces.

According to the above-mentioned configuration, by performing the heating treatment under a state in which the bonding surface between the core plate glass and the surface-layer plate glass is brought into surface-to-surface contact in a close contact state, the core plate glass and the surface-layer plate glass are directly bonded at a temperature lower than the lower strain point out of those of the core plate glass and the surface-layer plate glass. The direct bonding of those plate glasses is realized under such low-temperature state as the above-mentioned temperature lower than the lower strain point, and hence the direct bonding is, as a matter of course, different from melting and bonding. The reason why the state described above can be obtained is derived from the fact that, as a result of the intensive study of the inventors of the present invention, the inventors have found that, if heating is performed under a state in which the bonding surface between the core plate glass and the surface-layer plate glass is brought into surface-to-surface contact to each other so as to attain a proper close contact state, the adjacent bonding surfaces are directly bonded even at a temperature lower than the above-mentioned lower strain point, and the adjacent bonding surfaces are not detached by an external stress that can usually act on the adjacent bonding surfaces. Further, because the core plate glass and the surface-layer plate glass are directly bonded to form a bound state as described above, the core plate glass and the surface-layer plate glass are temporarily fixed while being kept in a properly positioned state. Thus, after the core plate glass and the surface-layer plate glass are easily positioned or temporarily fixed under the low-temperature state, the core plate glass and the surface-layer plate glass can be subjected to the subsequent heating under high temperature while the displacement of the relative position between the core plate glass and the surface-layer plate glass is being prevented. That is, after the core plate glass and the surface-layer plate glass are temporarily fixed by being directly bonded under the low-temperature state, the surface-to-surface contact portion is heated at a temperature equal to or higher than the lower strain point out of the strain points of the core plate glass and the surface-layer plate glasses. As a result, the core plate glass and the surface-layer plate glass are integrated as a laminate and the difference in internal stress between the core plate glass and the surface-layer plate glass substantially disappears. Besides, because the surface-to-surface contact portion of the core plate glass and the surface-layer plate glass has already been bounded, it becomes unnecessary to apply a large pressing force to the surface-to-surface contact portion under a high-temperature state, and the displacement of the relative position, the loss of shape, and the like can be suppressed from occurring in the surface-to-surface contact portion as much as possible. After that, the laminate of the core plate glass and the surface-layer plate glass is cooled to below the above-mentioned lower strain point, thereby causing the difference in internal stress between the core plate glass and the surface-layer plate glass. As a result, in the laminate, a compression stress is formed in the surface layer portion corresponding to the surface-layer plate glass and a tensile stress is formed in the core portion corresponding to the core plate glass, thereby yielding a high-quality reinforced plate glass.

If the reinforced plate glass is manufactured via the process described above, eliminated or simplified is means for accurately positioning the core plate glass and the surface-layer plate glass with a jig or a special apparatus and temporarily fixing the core plate glass and the surface-layer plate glass externally, until the core plate glass and the surface-layer plate glass (their surface-to-surface contact portion) reach the high-temperature state equal to or higher than the lower strain point, or until the reinforced plate glass is manufactured. Moreover, means for externally applying a relatively large pressing force to the surface-to-surface contact portion until the core plate glass and the surface-layer plate glass are bonded or melt-bonded is also eliminated or simplified. In other words, if this manufacturing method is used, the core plate glass and the surface-layer plate glass are temporarily fixed to each other while the surface-to-surface contact portion itself, which is desired to be bonded or melt-bonded to each other, is in the low-temperature state lower than the lower strain point. As a result, it becomes not always necessary to use a jig or an apparatus for temporarily fixing the core plate glass and the surface-layer plate glass externally, the core plate glass and the surface-layer plate glass can be maintained in an accurately positioned state up to the final stage, and it becomes unnecessary to apply a large pressing force externally to the surface-to-surface contact portion in which the core plate glass and the surface-layer plate glass have already been bounded by temporary fixing. Use of this method can reduce the cost of equipment and the production cost, can contribute to improving workability and productivity, and becomes extremely advantageous for obtaining a high-quality reinforced plate glass. Note that, in order to obtain a reinforced plate glass by following the procedure described above, a redraw method may be adopted other than a technique of simply applying heat treatment to the core plate glass and the surface-layer plate glass (such as heat technique in a furnace).

In such a configuration, it is preferred that, after the directly bonding the core plate glass and the surface-layer plate glass, the heat treatment be performed so that the portion of the surface-to-surface contact has a temperature equal to or higher than the lower strain point and lower than a lower softening point out of the strain points of the core plate glass and the surface-layer plate glass and softening points of the core plate glass and the surface-layer plate glass.

With this, the core plate glass and the surface-layer plate glass are not subjected to a temperature equal to or higher than the lower softening point, and hence the core plate glass and the surface-layer plate glass do not become a molten state. As a result, equipment, which is necessary for heating, is simplified, and it is possible to avoid such a situation that the surface property and conditions of the outer surfaces of the core plate glass and the surface-layer plate glass deteriorate or the core plate glass and the surface-layer plate glass has strain or bending. Thus, more advantageous conditions for manufacturing a high-quality reinforced plate glass are provided.

In the above-mentioned configurations, after directly bonding the core plate glass and the surface-layer plate glass, the heat treatment may be performed so that the surface-to-surface contact portion has a temperature equal to or higher than a lower annealing point out of annealing points of the core plate glass and the surface-layer plate glass.

With this, because the annealing point of glass is higher than its strain point, the difference in internal stress between the core plate glass and the surface-layer plate glass can be eliminated more reliably, and each of the tensile stress and the compression stress can be formed in the core plate glass and the surface-layer plate glass more reliably. Note that, substantially the same functional effect can be obtained even if a glass transition point is used instead of the glass annealing point.

In the configuration as described above, it is preferred that the bonding surface of the surface-layer plate glass and the core plate glass has a surface roughness Ra of 2.0 nm or less.

With this, the bonding surface between the surface-layer plate glass and the core plate glass can be brought into surface-to-surface contact in a closely bonded state or a state in which the adjacent bonding surfaces are certainly in close contact to such an extent as resembling to the closely bonded state, and hence the core plate glass and the surface-layer plate glass are directly bonded more reliably at a temperature lower than the lower strain point. The reason why the above-mentioned direct bonding is, as described above, realized more reliably when the bonding surface between the core plate glass and the surface-layer plate glass has a surface roughness Ra of 2.0 nm or less is derived from the fact that, as a result of the intensive study of the inventors of the present invention, the inventors have found that, reliably realizing the above-mentioned direct bonding by heating in a low-temperature state lower than a temperature at which the strain point is reached significantly depends on the surface roughness Ra of the bonding surface between the core plate glass and the surface-layer plate glass. Moreover, the inventors of the present invention have also found that the direct bonding of the core plate glass and the surface-layer plate glass is realized more reliably as the surface roughness Ra of the bonding surface becomes smaller, to be specific, becomes not only 2.0 nm or less, but also more preferably 1.0 nm or less, still more preferably 0.5 nm or less, most preferably 0.2 nm or less.

In the above-mentioned configuration, there may be possible that the surface-layer plate glass is formed of one plate glass or a laminated plate glass including a plurality of plate glasses being laminated together, and the core plate glass is formed of one plate glass or a laminated plate glass including a plurality of plate glasses being laminated together; and the surface-layer plate glass is arranged on both sides of the core plate glass in a thickness direction.

That is, the reinforced plate glass may have a configuration in which surface-layer plate glass formed of one plate glass is arranged on both sides of the core plate glass in the thickness direction, may have a configuration in which surface-layer plate glass formed of the laminated plate glass including a plurality of plate glasses being laminated together is arranged on both sides of a core plate glass in the thickness direction, may have a configuration in which the surface-layer plate glass is arranged on both sides of the core plate glass formed of one plate glass in the thickness direction, or may have a configuration in which the surface-layer plate glass is arranged on both sides of the core plate glass formed of the laminated plate glass including a plurality of plate glasses being laminated together in the thickness direction. In this case, as a technique of laminating a plurality of plate glasses to make the surface-layer plate glass and the core plate glass, it is preferred to use a technique utilizing the same direct bonding as that in the above-mentioned invention.

In the above-mentioned configuration, it is preferred that the surface-layer plate glass have a thickness equal to or less than one third of the thickness of the core plate glass.

With this, it is possible to avoid a situation in which the balance between a compression stress formed in the surface layer portions corresponding to the surface-layer plate glass and a tensile stress formed in the core portion corresponding to the core plate glass is improperly impaired. Thus, a reinforced plate glass in which proper reinforcement treatment is provided without any strain or bending can be obtained.

In the above-mentioned configurations, the surface-layer plate glass preferably has a thickness of 200 μm or less.

With this, even a thin surface-layer plate glass having a thickness of 200 μm or less can be directly bonded to a core plate glass in the low-temperature state, and hence there is effectively avoided an inconvenience that the thin surface-layer plate glass easily turns to a molten state, hindering the manufacture of a reinforced plate glass. Note that, the upper limit of the thickness of the surface-layer plate glass can be set to 300 μm or 100 μm, and the lower limit of the thickness can be set to 10 μm or 20 μm.

In the above-mentioned configuration, it is preferred that the bonding surface of the surface-layer plate glass and the core plate glass have a GI value of 1,000 pcs/m² or less.

With this, the bonding surface of the core plate glass and the surface-layer plate glass are clean, and hence the degree of activity of the bonding surface is not impaired, and it may be ensured that the core plate glass and the surface-layer plate glass are directly bonded and the direct bonding may be maintained properly.

In the above-mentioned configuration, it is preferred that the core plate glass and the surface-layer plate glass are formed by an overflow down-draw method.

With this, the bonding surface of the core plate glass and the surface-layer plate glass can be produced so as to have property and a condition of a high-precision surface formed of a mirror surface or a surface similar to the mirror surface, without requiring any polishing process. Thus, the core plate glass and the surface-layer plate glass can be directly bonded more reliably. As a result, the improvement of workability and productivity can be attained by further lowering the temperature which should be maintained until the core plate glass and the surface-layer plate glass are directly bonded, and the core plate glass and the surface-layer plate glass can be bonded more firmly.

In the method for manufacturing a reinforced plate glass described in the beginning of “Solution to Problem”, the above-mentioned advantages in the process of manufacturing a reinforced glass plate can certainly be provided through the step of forming a compression stress in the core portion corresponding to the core plate glass, as a pre-step of performing the heat treatment so that the surface-to-surface contact portion has a temperature equal to or higher than the lower strain point and as a post-step of directly bonding the core plate glass and the surface-layer plate glass.

That is, after the bonding surfaces between the core plate glass and the surface-layer plate glass are directly bonded at a temperature lower than the lower strain point (for example, approximately 300° C. in the range of from 200° C. to 400° C.), the core plate glass and the surface-layer plate glass are heated from the temperature to the lower strain point. Thus, a compression stress is formed in the core plate glass having a higher thermal expansion coefficient and a tensile stress is formed in the surface-layer plate glass having a lower thermal expansion coefficient. This means that the core plate glass and the surface-layer plate glass are directly bonded reliably in a low-temperature state lower than the lower strain point. Thus, the core plate glass and the surface-layer plate glass are subsequently heated to a temperature equal to or higher than the lower strain point, leading to the disappearance of the tensile stress and compression stress in the core plate glass and the surface-layer plate glass. After that, the core plate glass and the surface-layer plate glass are cooled to a temperature lower than the lower strain point, thereby yielding a reinforced plate glass in which a tensile stress and a compression stress are formed in the surface layer portion and the core portion, respectively, which is a state reverse to that described above. Besides, once the core plate glass and the surface-layer plate glass are directly bonded in such a series of treatment, the core plate glass and the surface-layer plate glass are not detached. Therefore, under the state in which proper and favorable temporary fixing is performed, the subsequent treatment is smoothly carried out, and the core plate glass and the surface-layer plate glass are maintained in the directly bonded state until the final stage.

A reinforced plate glass according to the present invention, which has been devised for solving the above-mentioned technical problems, is obtained by: performing heat treatment under a state in which a thick core plate glass having a higher thermal expansion coefficient and a thin surface-layer plate glass having a lower thermal expansion coefficient are brought into surface-to-surface contact so that a bonding surface between the core plate glass and the surface-layer plate glass attain a close contact state, thereby directly bonding the core plate glass and the surface-layer plate glass; then, additionally performing heat treatment so that the surface-to-surface contact portion has a temperature equal to or higher than a lower strain point out of strain points of the core plate glass and the surface-layer plate glass; and then, performing cooling so as to attain a temperature lower than the lower strain point, to thereby form a compression stress in a surface layer portion corresponding to the surface-layer plate glass and form a tensile stress in a core portion corresponding to the core plate glass.

The description items of the reinforced plate glass having this configuration, including its functional effects, are substantially the same as the above-mentioned description items of the method according to the present invention, the method including substantially the same configurational elements as the reinforced plate glass.

### Advantageous Effects of Invention

As described above, according to the present invention, by performing the heating treatment under the state in which the bonding surface between the core plate glass and surface-layer plate glass is brought into surface-to-surface contact in a close contact state, the core plate glass and the surface-layer plate glass are directly bonded at a temperature lower than the lower strain point out of those of the core plate glass and the surface-layer plate glass, and the core plate glass and the surface-layer plate glass can be positioned and be temporarily fixed. Then, the subsequent heating treatment under high temperature is carried out while the displacement of the relative position between the core plate glass and the surface-layer plate glass is being prevented, followed by cooling. As a result, the reinforced plate glass can be obtained. With this, means for positioning and temporarily fixing the core plate glass and the surface-layer plate glass under a high-temperature state is eliminated or simplified, the reduction of the cost of equipment and the reduction of the production cost are attained, contribution to improving workability and productivity can be made, and moreover, the high-quality reinforced plate glass can be obtained.

### BRIEF DESCRIPTION OF DRAWINGS

FIG. 1 is a cross-sectional view illustrating a reinforced plate glass according to an embodiment of the present invention.

FIG. 2a is a schematic view illustrating a part of a manufacturing process of the reinforced plate glass according to the embodiment of the present invention.

FIG. 2b is a schematic view illustrating another part of the manufacturing process of the reinforced plate glass according to the embodiment of the present invention.

FIG. 2c is a schematic view illustrating still another part of the manufacturing process of the reinforced plate glass according to the embodiment of the present invention.

FIG. 2d is a schematic view illustrating still another part of the manufacturing process of the reinforced plate glass according to the embodiment of the present invention.

### DESCRIPTION OF EMBODIMENT

Hereinafter, an embodiment of the present invention is described based on the accompanying drawings.

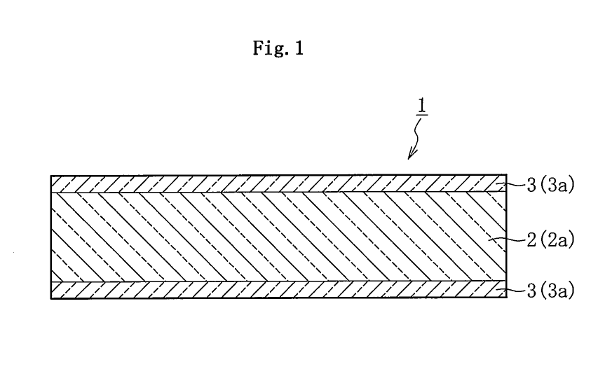

FIG. 1 illustrates a reinforced plate glass 1 according to this embodiment. The reinforced plate glass 1 is, for example, a reinforced plate glass to be mounted on an electronic device such as a touch panel, a display, or a solar cell, the reinforced plate glass being required particularly for outdoor installation.

As illustrated in the figure, the reinforced plate glass 1 is a glass laminate which has a three-layer structure including a core portion 2 corresponding to a core plate glass 2a and surface layer portions 3 corresponding to surface-layer plate glasses 3a each arranged on each of both surface sides of the core plate glass 2a in its thickness direction. That is, the reinforced plate glass 1 is one obtained by producing the core plate glass 2a forming the core portion 2 and the surface-layer plate glasses 3a forming the surface layer portions 3 by, for example, an overflow down-draw method, and closely fixing one core plate glass 2a forming the core portion 2 and two surface-layer plate glasses 3a forming the surface layer portions 3 by direct bonding under the state in which the core plate glass 2a is sandwiched by the surface-layer plate glasses 3a.

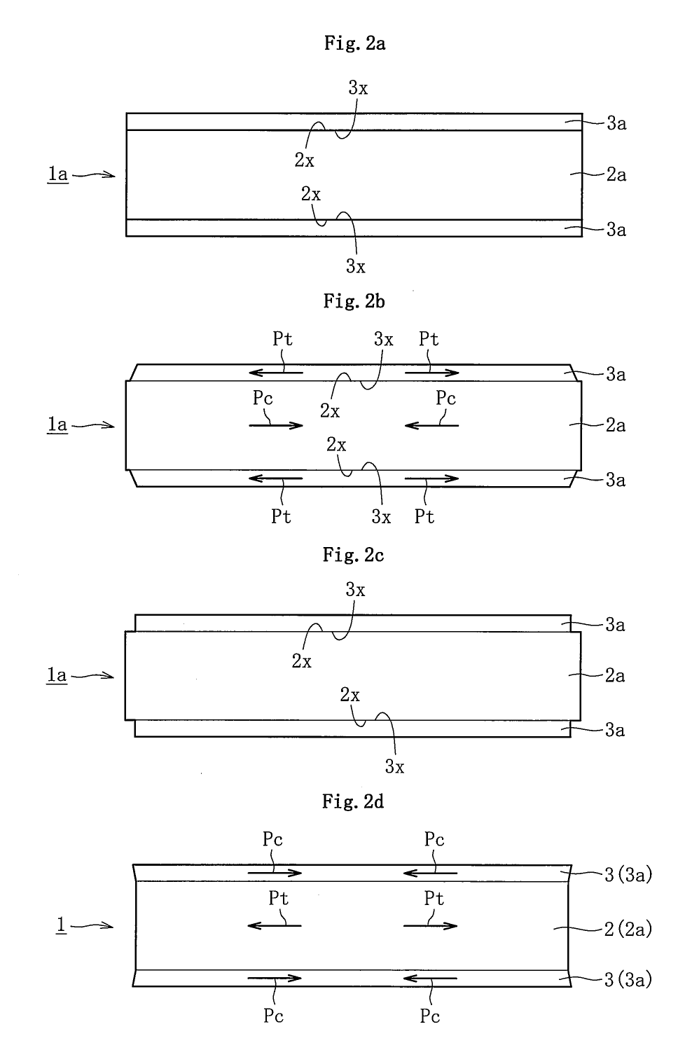

In the reinforced plate glass 1, the surface layer portions 3 should be relatively thinner than the core portion 2, and the thickness of the surface layer portions 3 is preferably equal to or less than one third of the thickness of the core portion 2, more preferably equal to or less than one tenth, still more preferably equal to or less than one fifties. Besides, the thermal expansion coefficient of the core portion 2 should be larger than the thermal expansion coefficient of the surface layer portions 3, and a difference in thermal expansion coefficient between the core portion 2 and each of the surface layer portions 3 at 30 to 380° C. is set to 5×10⁻⁷/° C. to 50×10⁻⁷/° C. Further, as illustrated in FIG. 2d, a compression stress Pc of 50 to 350 MPa is formed in each of the surface layer portions 3 and a tensile stress Pt of 1 to 100 MPa is formed in the core portion 2.

Further, the surface layer portions 3 are each made up of glass containing substantially no alkali metal oxides as its glass composition, and the core portion 2 is made up of glass containing substantially no alkali metal oxides as its glass composition or glass substantially containing alkali metal oxides as its glass composition. The phrase “containing substantially no alkali metal oxides” specifically refers to the state in which the content of alkali metal oxides is 1000 ppm or less. The content of alkali metal oxides in the surface layer portions 3 and the core portion 2 is preferably 500 ppm or less, more preferably 300 ppm or less.

Further, the reinforced plate glass 1 is approximately formed as described below. That is, the reinforced plate glass 1 is manufactured by performing heat treatment under the state in which a thick core plate glass 2a having a higher thermal expansion coefficient and thin surface-layer plate glasses 3a having a lower thermal expansion coefficient are brought into surface-to-surface contact so that the bonding surfaces between the core plate glass and the surface-layer plate glasses attain a close contact state, thereby directly bonding both the core plate glass 2a and the surface-layer plate glasses 3a, then, additionally performing heat treatment so that each of the surface-to-surface contact portions has a temperature equal to or higher than the lower strain point out of strain points of the core plate glass 2a and the surface-layer plate glasses 3a, and then, performing cooling so as to attain a temperature lower than the lower strain point, to thereby form a compression stress in surface layer portions 3 corresponding to the surface-layer plate glasses 3a and form a tensile stress in a core portion 2 corresponding to the core plate glass 2a.

Next, a method for manufacturing the reinforced plate glass 1 is described step by step in accordance with FIG. 2a to FIG. 2d, which schematically illustrate the method.

First, as illustrated in FIG. 2a, each of bonding surfaces 2x of one core plate glass 2a and a bonding surface 3x of each of two surface-layer plate glasses 3a are brought into surface-to-surface contact at, for example, room temperature of 20° C. so that each pair of the adjacent bonding surfaces 2x and 3x attains a close contact state, thereby laminating those plate glasses 2a and 3a to form three layers, and each relative position between the core plate glass 2a and the surface-layer plate glasses 3a is accurately adjusted. In this case, both the surface roughness Ra of each of the bonding surfaces 2x of the core plate glass 2a and the surface roughness Ra of the bonding surface 3x of each of the surface-layer plate glasses 3a are preferably 2.0 nm or less, more preferably 1.0 nm or less, still more preferably 0.5 nm or less, most preferably 0.2 nm or less, and 0.2 nm or less in this embodiment. In addition, the GI values of the bonding surfaces 2x of the core plate glass 2a and the GI values of the bonding surfaces 3x of the surface-layer plate glasses 3a are each 1,000 pcs/m² or less.

The above-mentioned core plate glass 2a and surface-layer plate glasses 3a were each formed by an overflow down-draw method, and the unpolished surfaces of the resultant glasses were used as bonding surfaces 2x and 3x without any further treatment. Note that, the surface roughnesses Ra of the bonding surfaces 2x and 3x of the core plate glass 2a and the surface-layer plate glasses 3a were measured by using an AFM (Nanoscope III a) manufactured by Veeco Instruments Inc. On the other hand, the GI values of the core plate glass 2a and surface-layer plate glasses 3a were controlled by adjusting the amounts of dust in water and in air through washing and the control of indoor air conditioning, to thereby adjust the amounts of dust attaching to the bonding surfaces 2x and 3x of the core plate glass 2a and the surface-layer plate glasses 3a. The GI values were measured by using G17000 manufactured by Hitachi High-Tech Electronics Engineering Co., Ltd.

Next, heat treatment is applied in a furnace to a glass plate laminate 1a produced by, as described above, laminating the core plate glass 2a and the surface-layer plate glasses 3a to form three layers. As a result, when the temperature of the surface-to-surface contact portions between the core plate glass 2a and the surface-layer plate glasses 3a reaches approximately 300° C., the bonding surfaces 2x and 3x of the core plate glass 2a and the surface-layer plate glasses 3a are directly bonded to form a bound state. As a result, the core plate glass 2a and the surface-layer plate glasses 3a are temporarily fixed while keeping the accurately positioned original state, even in a low-temperature state of approximately 300° C. From the state described above, the temperature in the furnace is further increased, and hence, as illustrated in FIG. 2b, a tensile stress Pt is formed in each of the surface-layer plate glasses 3a and a compression stress Pc is formed in the core plate glass 2a.

From the state described above, the temperature in the furnace is further increased, and the temperature of each surface-to-surface contact portion between the core plate glass 2a and the surface-layer plate glasses 3a reaches a temperature equal to or higher than the lower strain point out of the strain points of the core plate glass 2a and the surface-layer plate glasses 3a. As a result, as illustrated in FIG. 2c, the tensile stress and the compression stress formed in the surface-layer plate glasses 3a and the core plate glass 2a, respectively, disappear. At this time, the surface-layer plate glasses 3a and the core plate glass 2a expand with different thermal expansion levels while keeping the state in which the surface-layer plate glasses 3a and the core plate glass 2a are closely fixed by direct contact. Then, heating is performed in the furnace in the range of temperature lower than the lower softening point out of the softening points of the core plate glass 2a and the surface-layer plate glasses 3a, and cooling is subsequently performed until the temperature reaches below the above-mentioned lower strain point.

As a result, as illustrated in FIG. 2d, the reinforced plate glass 1 is obtained, in which a tensile stress Pt is formed in the core portion 2 corresponding to the core plate glass 2a, and a compression stress Pc is formed in each of the surface layer portions 3 corresponding to the surface-layer plate glasses 3a. In this case, when the above-mentioned heating in the furnace is performed, the surface-to-surface contact portions between each of the surface-layer plate glasses 3a and the core plate glass 2a do not have a temperature equal to or higher than the lower softening point, and hence each of the surface-to-surface contact portions does not turn to a molten state but remains in a solidified state. Note that, the surface-to-surface contact portions may be heated to a temperature equal to or higher than the above-mentioned lower softening point or a temperature equal to or higher than the higher softening point.

According to the manufacturing method described above, the core plate glass 2a and the surface-layer plate glasses 3a are directly bonded to form a closely fixed state at approximately 300° C. in the midst of transition from FIG. 2a to FIG. 2b described above, and hence the core plate glass 2a and the surface-layer plate glasses 3a are temporarily fixed under the low-temperature state, which is a stage before turning to a high-temperature state equal to or higher than the lower strain point. Then, after the temporary fixing, the position of each of the core plate glass 2a and the surface-layer plate glasses 3a is not displaced even if the core plate glass 2a and the surface-layer plate glasses 3a are in a high-temperature state equal to more than the lower strain point. The core plate glass 2a and the surface-layer plate glasses 3a are then heated while a correct, relative positional relationship in the temporarily fixed state is maintained. As a result, the core plate glass 2a and the surface-layer plate glasses 3a are directly bonded firmly (melt-bonded when heated to a temperature equal to or higher than one of the softening points) in the accurately positioned state, yielding the reinforced plate glass 1 having high quality.

That is, when conventional manufacturing methods were used, it was necessary to accurately position each plate glass with a jig or a special apparatus and temporarily fix the each plate glass externally, until the each plate glass (each surface-to-surface contact portion thereof) reached a high-temperature state equal to or higher than its strain point, or until a reinforced plate glass was manufactured. Besides, it was necessary to apply a relatively large pressing force externally to the each surface-to-surface contact portion until the each plate glass was bonded or melt-bonded to each other. In contrast, when the above-mentioned manufacturing method according to this embodiment is used, each plate glass 2a or 3a is temporarily fixed to each other while each surface-to-surface contact portion itself which is desired to be bonded or melt-bonded to each other is in a low-temperature state. As a result, it becomes not always necessary to use a jig or an apparatus for temporarily fixing the core plate glass and the surface-layer plate glasses externally, the core plate glass and the surface-layer plate glasses can be maintained in the accurately positioned up to the final stage, and moreover, it becomes unnecessary to apply a large pressing force externally to the each surface-to-surface contact portion which is a temporarily fixed portion. Using this method can reduce the cost of equipment and production cost and can improve workability and productivity.

Note that, in the above-mentioned embodiment, the core portion 2 in the reinforced plate glass 1 was formed by one core plate glass 2a, but two or more core plate glasses 2a may be used to form the core portion 2 having a plurality of layers, or alternatively or additionally, two or more surface-layer plate glasses 3a may be used to form the surface-layer portion 3 having a plurality of layers for each of the two surface-layer portions 3.

Further, in the above-mentioned embodiment, the reinforced plate glass 1 was produced by applying heat treatment in a furnace to the glass laminate which includes the core plate glass 2a and the surface-layer plate glasses 3a laminated under surface-to-surface contact. However, it is also possible to produce a similar reinforced plate glass by adopting a redraw method under a theoretical configuration similar to the above-mentioned embodiment.

### REFERENCE SIGNS LIST

1 reinforced plate glass
1a glass plate laminate
2 core portion
2a core plate glass
2x bonding surface of core plate glass
3 surface layer portion
3a surface-layer plate glass
3x bonding surface of surface-layer plate glass
Pc compression stress
Pt tensile stress

1. A method for manufacturing a reinforced plate glass, comprising:
performing heat treatment under a state in which a thick core plate glass having a higher thermal expansion coefficient and a thin surface-layer plate glass having a lower thermal expansion coefficient are brought into surface-to-surface contact so that a bonding surface between the core plate glass and the surface-layer plate glass attain a close contact state, thereby directly bonding the core plate glass and the surface-layer plate glass;
then, additionally performing heat treatment so that the surface-to-surface contact portion has a temperature equal to or higher than a lower strain point out of strain points of the core plate glass and the surface-layer plate glass; and then,
performing cooling so as to attain a temperature lower than the lower strain point, to thereby form a compression stress in a surface layer portion corresponding to the surface-layer plate glass and form a tensile stress in a core portion corresponding to the core plate glass.

2. The method for manufacturing a reinforced plate glass according to claim 1, wherein, after directly bonding the core plate glass and the surface-layer plate glass, the heat treatment is performed so that the portion of the surface-to-surface contact has a temperature equal to or higher than the lower strain point and lower than a lower softening point out of the strain points of the core plate glass and the surface-layer plate glass and softening points of the core plate glass and the surface-layer plate glass.

3. The method for manufacturing a reinforced plate glass according to claim 1, wherein, after directly bonding the core plate glass and the surface-layer plate glass, the heat treatment is performed so that the portion of the surface-to-surface contact has a temperature equal to or higher than a lower annealing point out of annealing points of the core plate glass and the surface-layer plate glass.

4. The method for manufacturing a reinforced plate glass according to claim 1, wherein the bonding surface of the surface-layer plate glass and the core plate glass has a surface roughness Ra of 2.0 nm or less.

5. The method for manufacturing a reinforced plate glass according to claim 1, wherein:
the surface-layer plate glass comprises one plate glass or a laminated plate glass including a plurality of plate glasses being laminated together, and the core plate glass comprises one plate glass or a laminated plate glass including a plurality of plate glasses being laminated together; and
the surface-layer plate glass is arranged on both sides of the core plate glass in a thickness direction thereof.

6. The method for manufacturing a reinforced plate glass according to claim 1, wherein the surface-layer plate glass has a thickness equal to or less than one third of the thickness of the core plate glass.

7. The method for manufacturing a reinforced plate glass according to claim 1, wherein the bonding surface of the surface-layer plate glass and the core plate glass has a GI value of 1,000 pcs/m² or less.

8. The method for manufacturing a reinforced plate glass according to claim 1, wherein the core plate glass and the surface-layer plate glass are formed by an overflow down-draw method.

9. The method for manufacturing a reinforced plate glass according to claim 1, further comprising forming a compression stress in the core portion corresponding to the core plate glass, as a pre-step of performing the heat treatment so that the portion of the surface-to-surface contact has a temperature equal to or higher than the lower strain point and as a post-step of directly bonding the core plate glass and the surface-layer plate glass.

10. A reinforced plate glass, which is obtained by:
performing heat treatment under a state in which a thick core plate glass having a higher thermal expansion coefficient and a thin surface-layer plate glass having a lower thermal expansion coefficient are brought into surface-to-surface contact so that a bonding surface between the core plate glass and the surface-layer plate glass attain a close contact state, thereby directly bonding the core plate glass and the surface-layer plate glass;
then, additionally performing heat treatment so that the surface-to-surface contact portion has a temperature equal to or higher than a lower strain point out of strain points of the core plate glass and the surface-layer plate glass; and then,
performing cooling so as to attain a temperature lower than the lower strain point, to thereby form a compression stress in a surface layer portion corresponding to the surface-layer plate glass and form a tensile stress in a core portion corresponding to the core plate glass.

11. The method for manufacturing a reinforced plate glass according to claim 2, wherein, after directly bonding the core plate glass and the surface-layer plate glass, the heat treatment is performed so that the portion of the surface-to-surface contact has a temperature equal to or higher than a lower annealing point out of annealing points of the core plate glass and the surface-layer plate glass.
